(19) United States
(12) Patent Application Publication
(10) Pub. No.: US 2024/0142694 A1
(43) Pub. Date: May 2, 2024

(54) 3D PRINT MICROSTRUCTURES FOR AR WAVEGUIDE PACKAGING AND PROTECTION

(71) Applicant: Meta Platforms Technologies, LLC, Menlo Park, CA (US)

(72) Inventors: Rongzhi HUANG, Sammamish, WA (US); Daniel PUSKAS, Eindhoven (NL); Richard FARRELL, Seattle, WA (US); Kurt JENKINS, Sammamish, WA (US); Guido GROET, Issaquah, WA (US); Helia RAHMANI, Mountain View, CA (US); Keren ZHANG, Woodinville, WA (US)

(21) Appl. No.: 18/409,180

(22) Filed: Jan. 10, 2024

Related U.S. Application Data
(60) Provisional application No. 63/483,845, filed on Feb. 8, 2023.

(51) Int. Cl. F21V 8/00; G02B 27/01

(52) U.S. Cl. CPC G02B 6/0088; G02B 6/0065; G02B 27/0172; G02B 2027/0178

(57) ABSTRACT

Techniques, systems, and assemblies are presented relating to micro spacers positioned between optical substrates. In some embodiments, a stacked optical assembly comprises a first optical substrate having a first index of refraction greater than 1.4, a second optical substrate having a second index of refraction greater than 1.4 and disposed in a stacked position relative to the first optical substrate, and a plurality of micro spacers positioned between the first optical substrate and the second optical substrate. The plurality of micro spacers may maintain a gap having a gap height between the first optical substrate and the second optical substrate. The plurality of micro spacers may be fixedly attached to (a) the first optical substrate, (b) the second optical substrate, or (c) both the first optical substrate and the second optical substrate.

### CROSS-REFERENCE TO RELATED APPLICATIONS

This application claims the benefit of U.S. Provisional Application No. 63/483,845, filed Feb. 8, 2023, entitled “3D PRINT MICROSTRUCTURES FOR AR WAVEGUIDE PACKAGING AND PROTECTION” which is incorporated herein by reference in its entirety.

### BACKGROUND

Optical systems such as those employed in artificial reality (AR), virtual reality (VR), and mixed reality (MR) glasses and goggles are becoming ever more complex. With added functionality, the number of components, weight, and physical size of the overall system have correspondingly increased, which can negatively impact user experience and comfort. At the same time, bulky structural elements and additional tolerances are sometimes incorporated to improve durability against damage from collision, drops, or rough handling, which adds further weight and overall size. There is a need for improved optical system design that preserves functionality and durability yet elevates user experience and comfort.

### SUMMARY

The present disclosure presents techniques, systems, and assemblies relating to micro spacers positioned between optical substrates. In some embodiments, a stacked optical assembly comprises a first optical substrate having a first index of refraction greater than 1.4, a second optical substrate having a second index of refraction greater than 1.4 and disposed in a stacked position relative to the first optical substrate, and a plurality of micro spacers positioned between the first optical substrate and the second optical substrate. The plurality of micro spacers may maintain a gap having a gap height between the first optical substrate and the second optical substrate. The plurality of micro spacers may be fixedly attached to (a) the first optical substrate, (b) the second optical substrate, or (c) both the first optical substrate and the second optical substrate. The gap maintained by the micro spacers between the first optical substrate and the second optical substrate may comprise a vacuum or partial vacuum, or may be at least partially occupied by a material having a third index of refraction less than 1.1.

In some embodiments, the plurality of micro spacers are arranged in a defined pattern having a non-uniform spacer density. In some embodiments, the non-uniform spacer density decreases when moving from a central region of the defined pattern toward a peripheral region of the defined pattern. In some embodiments, the defined pattern corresponds to a hexagonal grid, a rectangular grid, or a star shape. In some embodiments, each of the plurality of micro spacers is formed using a 3D printing process. In some embodiments, each of the plurality of micro spacers comprises multiple layers of cured resin material. In some embodiments, for each of the plurality of micro spacers, each layer of the multiple layers of cured resin material comprises a layer cured from a single droplet of the resin material.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5A illustrates an example of a near-eye display device including a waveguide display according to certain embodiments.

FIG. 5B illustrates an example of a near-eye display device including a waveguide display according to certain embodiments.

FIG. 6 illustrates the use of micro spacers in the context of a pair of AR glasses, according to embodiments of the present disclosure.

FIG. 7A and FIG. 7B are cross-sectional views of examples of the use of micro spacers to maintain gaps between different optical substrates (e.g., different layers of optical elements).

FIGS. 8A and 8B further illustrate that micro spacers according to embodiments of the disclosure may be arranged in a defined pattern, such as a regular hexagonal pattern.

FIGS. 9A and 9B present examples of micro spacers arranged in defined patterns having non-uniform spacer density, according to different embodiments of the disclosure.

FIG. 10 illustrates a modified 3D printing system 1000 for forming micro spacers according to certain embodiments of the present disclosure.

FIG. 11 illustrates an example of an image source assembly in an augmented reality system according to certain embodiments.

FIG. 12 is a simplified block diagram of an electronic system of an example of a near-eye display according to certain embodiments.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to optical stack support and packaging. More specifically, and without limitation, disclosed herein are techniques for providing support for maintaining a gap between optical elements in an optical stack, e.g., to maintain proper total internal reflection (TIR) for waveguides while reducing weight and physical size of the overall system employing the optical stack. Various inventive embodiments are described herein, including devices, systems, methods, materials, and the like.

Existing AR, VR, and MR glasses and goggles typically include one or more optical stacks comprising a plurality of optical elements serving different functions. The complexity of the optical stack has increased with the advancement of AR/VR/MR systems, in order to incorporate more functionality. Deflection of one or more layers of optical elements within the optical stack, e.g., due to dropping, compressing, or just handling of the glasses or goggles during testing or use, can result in the inadvertent contact or collision of adjacent layers of optical elements. Such contact or collision can lead to failure to maintain TIR for the optical waveguide, as it comes into contact with other optical elements having similar indices of refraction, which can negatively impact the projection of images through the waveguide. Contact or collision can also lead to damage to optical elements within the optical stack.

To address these issues, existing AR.VR, and MR glasses and goggles typically employ bulky structural elements such as a thick cover glass to protect against collision or contact, or maintain large air gaps to provide sufficient clearance to allow a significant amount of deflection of one or more optical elements within the optical stack (e.g., during a drop test or while being compressed). However, the use of bulky structural members, as well as the incorporation of large clearances between layers of optical elements, can significantly increase the weight and/or physical size of the AR, VR, or MR glasses or goggles and, as a result, degrade user experience and comfort.

According to certain embodiments, micro structures such as micro pillars, cones, dots, stripes, blocks, etc., are used as spacers to maintain a gap, e.g., an air gap, between adjacent layers of optical elements. Use of the micro spacers allows for the gap height between adjacent optical elements to be significantly reduced (e.g., by an order of magnitude, as compared to existing AR/VR/MR glasses and goggles). The minimized gap height thus achieved is well-controlled and effectively resists compression and other forces that would otherwise bend an optical element and cause undesirable contact or collision between adjacent layers of optical elements.

The micro spacers may be placed within the field of view of a user of the AR, VR, or MR glasses or goggles, without significantly impacting the user's viewing experience. Selection of the size, distribution, materials, and design of the micro spacers may reduce any negative impacts such as occlusion of portions of the field of view or the loss of brightness of the displayed image. Overall, the micro spacers utilized according to embodiments of the disclosure can reduce the weight and physical size of AR, VR, or MR glasses or goggles while maintaining or even improving protection against performance degradation or damage associated with contact or collision of optical elements, e.g., from compression, dropping, or handling during testing or normal usage.

The structures and techniques described herein may be used in conjunction with various technologies, such as an artificial reality system. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through). In some AR systems, the artificial images may be presented to users using a light emitting diode (LED)-based display subsystem.

As used herein, the term “micro spacer” (or “micro structure”) refers to a structure that can provide support against a force, such as a compression force, to maintain a gap between layers in a stacked structure. A micro spacer according to various embodiments of the present disclosure has a linear dimension that is less than or equal to about 100 micrometers (μm). For example, a micro spacer may have a diameter of less than 100 μm, less than 50 μm, less than 30 lam, or between 10 μm and 20 μm. A micro spacer may have a height of less than 100 μm, less than 50 μm, or less than 30 μm. A micro spacer according to embodiments of the present disclosure may be composed of a polymer material, such as a resin. In some embodiments, the material is an ultraviolet (UV) light-curable resin. A micro spacer may be formed using a 3D printing process or modified 3D printing process as described in more details in the rest of the present disclosure.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

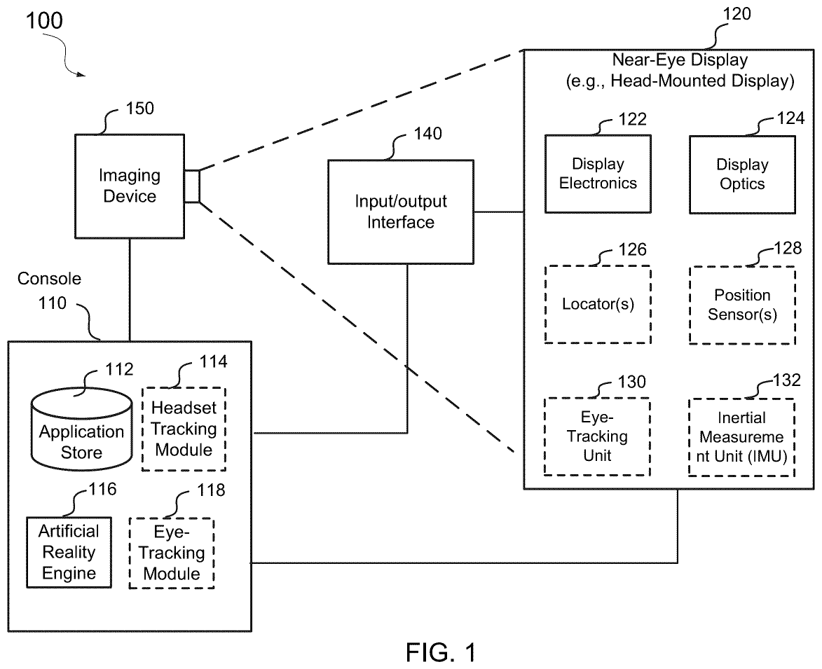

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

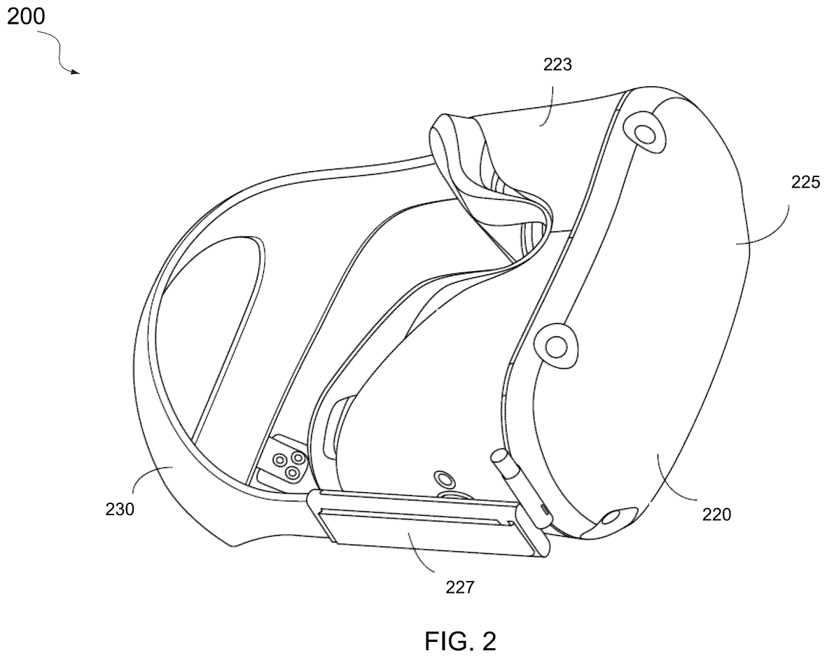

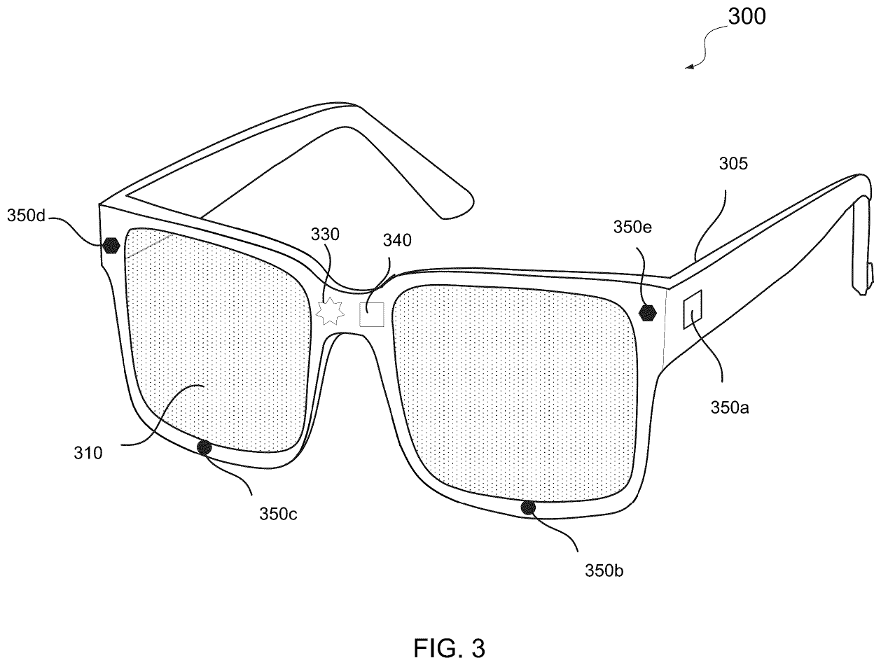

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an anti-reflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be an LED, a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

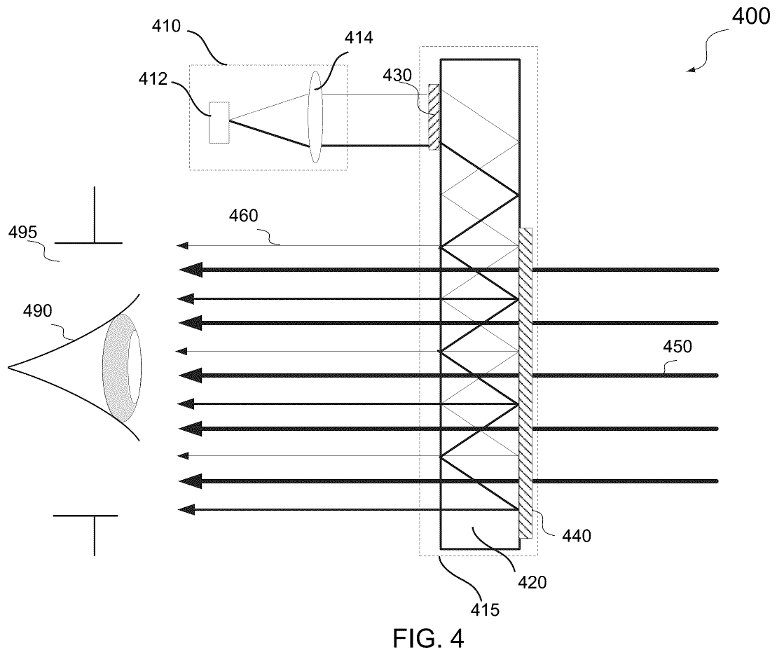

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Combiner 415 may transmit at least 50% of light in a first wavelength range and reflect at least 25% of light in a second wavelength range. For example, the first wavelength range may be visible light from about 400 nm to about 650 nm, and the second wavelength range may be in the infrared band, for example, from about 800 nm to about 1000 nm. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements (DOEs), prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

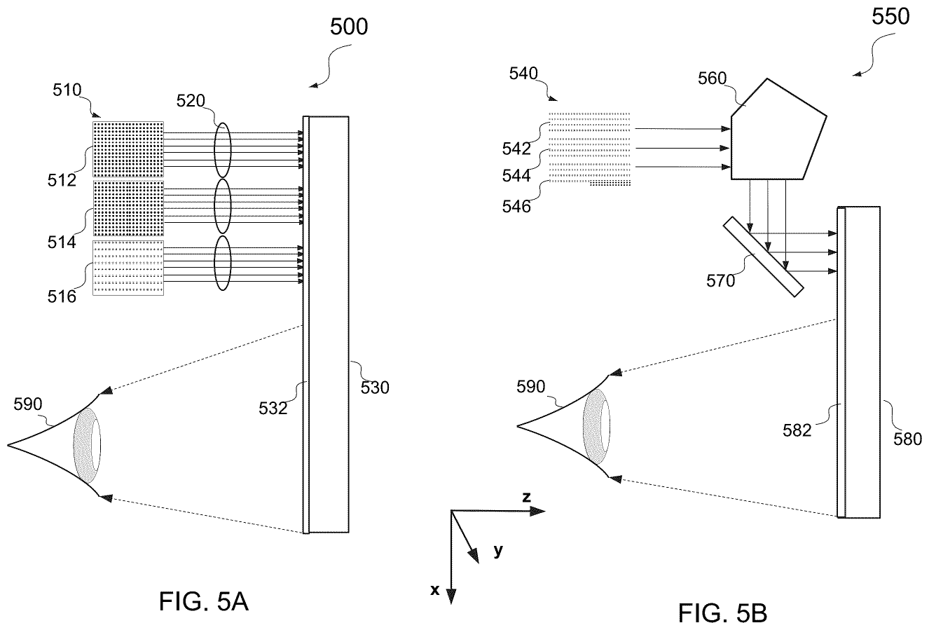

FIG. 5A illustrates an example of a near-eye display (NED) device 500 including a waveguide display 530 according to certain embodiments. NED device 500 may be an example of near-eye display 120, augmented reality system 400, or another type of display device. NED device 500 may include a light source 510, projection optics 520, and waveguide display 530. Light source 510 may include multiple panels of light emitters for different colors, such as a panel of red light emitters 512, a panel of green light emitters 514, and a panel of blue light emitters 516. The red light emitters 512 are organized into an array; the green light emitters 514 are organized into an array; and the blue light emitters 516 are organized into an array. The dimensions and pitches of light emitters in light source 510 may be small. For example, each light emitter may have a diameter less than 2 μm (e.g., about 1.2 μm) and the pitch may be less than 2 μm (e.g., about 1.5 μm). As such, the number of light emitters in each red light emitters 512, green light emitters 514, and blue light emitters 516 can be equal to or greater than the number of pixels in a display image, such as 960×720, 1280×720, 1440×1080, 1920×1080, 2160×1080, or 2560×1080 pixels. Thus, a display image may be generated simultaneously by light source 510. A scanning element may not be used in NED device 500.

Before reaching waveguide display 530, the light emitted by light source 510 may be conditioned by projection optics 520, which may include a lens array. Projection optics 520 may collimate or focus the light emitted by light source 510 to waveguide display 530, which may include a coupler 532 for coupling the light emitted by light source 510 into waveguide display 530. The light coupled into waveguide display 530 may propagate within waveguide display 530 through, for example, total internal reflection as described above with respect to FIG. 4. Coupler 532 may also couple portions of the light propagating within waveguide display 530 out of waveguide display 530 and towards user's eye 590.

FIG. 5B illustrates an example of a near-eye display (NED) device 550 including a waveguide display 580 according to certain embodiments. In some embodiments, NED device 550 may use a scanning mirror 570 to project light from a light source 540 to an image field where a user's eye 590 may be located. NED device 550 may be an example of near-eye display 120, augmented reality system 400, or another type of display device. Light source 540 may include one or more rows or one or more columns of light emitters of different colors, such as multiple rows of red light emitters 542, multiple rows of green light emitters 544, and multiple rows of blue light emitters 546. For example, red light emitters 542, green light emitters 544, and blue light emitters 546 may each include N rows, each row including, for example, 2560 light emitters (pixels). The red light emitters 542 are organized into an array; the green light emitters 544 are organized into an array; and the blue light emitters 546 are organized into an array. In some embodiments, light source 540 may include a single line of light emitters for each color. In some embodiments, light source 540 may include multiple columns of light emitters for each of red, green, and blue colors, where each column may include, for example, 1080 light emitters. In some embodiments, the dimensions and/or pitches of the light emitters in light source 540 may be relatively large (e.g., about 3-5 μm) and thus light source 540 may not include sufficient light emitters for simultaneously generating a full display image. For example, the number of light emitters for a single color may be fewer than the number of pixels (e.g., 2560×1080 pixels) in a display image. The light emitted by light source 540 may be a set of collimated or diverging beams of light.

Before reaching scanning mirror 570, the light emitted by light source 540 may be conditioned by various optical devices, such as collimating lenses or a freeform optical element 560. Freeform optical element 560 may include, for example, a multi-facet prism or another light folding element that may direct the light emitted by light source 540 towards scanning minor 570, such as changing the propagation direction of the light emitted by light source 540 by, for example, about 90° or larger. In some embodiments, freeform optical element 560 may be rotatable to scan the light. Scanning mirror 570 and/or freeform optical element 560 may reflect and project the light emitted by light source 540 to waveguide display 580, which may include a coupler 582 for coupling the light emitted by light source 540 into waveguide display 580. The light coupled into waveguide display 580 may propagate within waveguide display 580 through, for example, total internal reflection as described above with respect to FIG. 4. Coupler 582 may also couple portions of the light propagating within waveguide display 580 out of waveguide display 580 and towards user's eye 590.

Scanning mirror 570 may include a microelectromechanical system (MEMS) minor or any other suitable mirrors. Scanning mirror 570 may rotate to scan in one or two dimensions. As scanning mirror 570 rotates, the light emitted by light source 540 may be directed to a different area of waveguide display 580 such that a full display image may be projected onto waveguide display 580 and directed to user's eye 590 by waveguide display 580 in each scanning cycle. For example, in embodiments where light source 540 includes light emitters for all pixels in one or more rows or columns, scanning mirror 570 may be rotated in the column or row direction (e.g., x or y direction) to scan an image. In embodiments where light source 540 includes light emitters for some but not all pixels in one or more rows or columns, scanning mirror 570 may be rotated in both the row and column directions (e.g., both x and y directions) to project a display image (e.g., using a raster-type scanning pattern).

NED device 550 may operate in predefined display periods. A display period (e.g., display cycle) may refer to a duration of time in which a full image is scanned or projected. For example, a display period may be a reciprocal of the desired frame rate. In NED device 550 that includes scanning minor 570, the display period may also be referred to as a scanning period or scanning cycle. The light generation by light source 540 may be synchronized with the rotation of scanning mirror 570. For example, each scanning cycle may include multiple scanning steps, where light source 540 may generate a different light pattern in each respective scanning step.

In each scanning cycle, as scanning mirror 570 rotates, a display image may be projected onto waveguide display 580 and user's eye 590. The actual color value and light intensity (e.g., brightness) of a given pixel location of the display image may be an average of the light beams of the three colors (e.g., red, green, and blue) illuminating the pixel location during the scanning period. After completing a scanning period, scanning minor 570 may revert back to the initial position to project light for the first few rows of the next display image or may rotate in a reverse direction or scan pattern to project light for the next display image, where a new set of driving signals may be fed to light source 540. The same process may be repeated as scanning mirror 570 rotates in each scanning cycle. As such, different images may be projected to user's eye 590 in different scanning cycles.

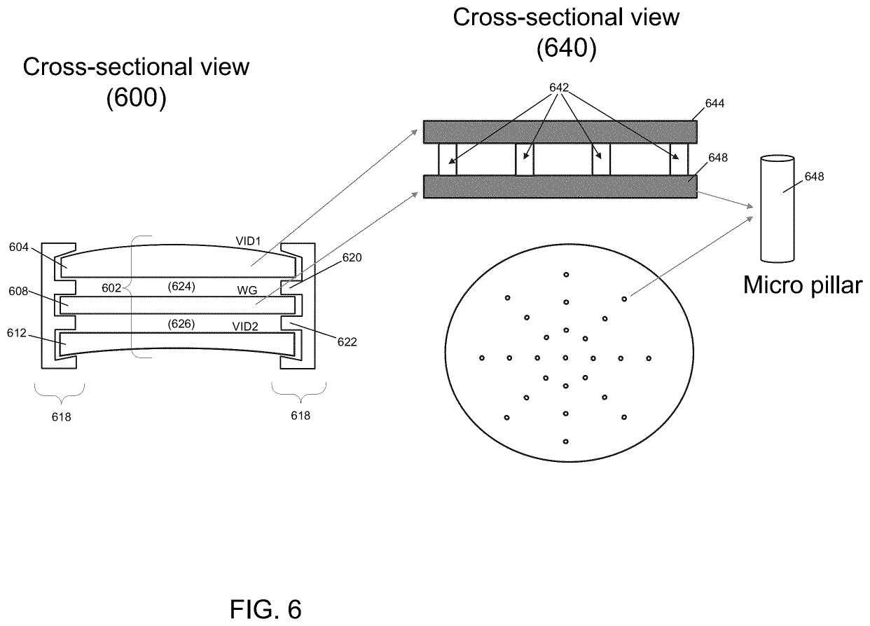

FIG. 6 illustrates the use of micro spacers in the context of a pair of AR glasses, according to embodiments of the present disclosure. A cross-sectional view 600 of a portion of a pair of AR glasses shows an optical stack 602 that includes multiple layers of optical elements. The optical stack 600 comprises first lens 604, an optical waveguide 608, and a second lens 612. The first lens 604, the second lens 612, or both, may comprise multiple layers that can provide various functionality. Such functionality may include, for example, vision correction, e.g., prescription (Rx) lens, eye tracking, dimming (including active dimming), various accommodations, etc. The first lens 604, the second lens 612, or both, may serve as a virtual image distance (VID) lens. The optical path traverses all or parts of the optical stack 602.

Real-world light from the external environment may enter the optical stack 602 at first lens 604, traverse the various layers of the optical stack 602, and exit the optical stack at the second lens 612, then enter the user's eye. One or more prescription layers (e.g., as part of the first lens 604, the second lens 612, or both) may provide optical power correction to sery as corrective eye wear for the user, when the user's vision require correction and regular corrective eye wear, such as glasses, are not being worn. One or more eye tracking layers (e.g., as part of the first lens 604, the second lens 612, or both) may support eye tracking operations, e.g., by providing glints that may serve as a frame of reference to determine the user's eye position based on an image captured of the user's eye. One or more dimming layers (e.g., as part of the first lens 604, the second lens 612, or both) may provide a dimming function to reduce brightness, particularly for the light from the external environment.

Projected light corresponding to the virtual image may be outputted by the optical waveguide 608, e.g., via the diffractive output grating (not shown), traverse the second lens 612, and exit the optical stack 602. If operating as a VID lens, the second lens 612 (or first lens 604) may place the projected light of the virtual image onto the same plane as the real-world light from the external environment. The optical waveguide 608, via total internal reflection (TIR) propagates projected light for a virtual image from a source such as an LED display toward the diffraction output grating 610. The diffraction output grating 610 directs the projected light out of optical waveguide 608 and toward an eye box associated with the user.

In certain embodiments, a plurality of structural elements 618 provide support for the optical stack 602 and maintain the relative positions of the layers of the optical stack 602 with respect to one another. The structural elements 618 comprise various framing members positioned at or near the peripheral regions of the optical stack 602. In a conventional AR system, the structural elements 618 may maintain relatively large air gaps between various layers of optical elements. For example, a framing member 620 may work in conjunction with other members of the structural elements 618 to maintain a large air gap 624 between the active dimming layer 606 and the diffraction output grating 610. As another example, a framing member 622 may work in conjunction with other members of the structural elements 618 to maintain another large air gap 626 between the optical waveguide 608 and the eye tracking layer 612. However, the relatively large air gaps 624 and 626, maintained by bulky structural members 618, contribute to increases in the weight and physical size of the AR glasses.

According to embodiments of the disclosure, micro spacers can be used to significantly reduce the gap height between optical elements while maintaining proper operation of the optical stack. In certain aspects, such an improved a stacked optical assembly comprises:
a first optical substrate having a first index of refraction greater than 1.4;
a second optical substrate having a second index of refraction greater than 1.4 and disposed in a stacked position relative to the first optical substrate; and
a plurality of micro spacers positioned between the first optical substrate and the second optical substrate, wherein:
the plurality of micro spacers maintain a gap having a minimum gap height between the first optical substrate and the second optical substrate,
the plurality of micro spacers are fixedly attached to (a) the first optical substrate, (b) the second optical substrate, or (c) both the first optical substrate and the second optical substrate, and
the gap maintained by the micro spacers between the first optical substrate and the second optical substrate comprises a vacuum or partial vacuum, or is at least partially occupied by a material having a third index of refraction less than 1.1.

For example, referring to the cross-sectional view 630 shown in FIG. 6, a plurality of micro spacers 642 may be used to maintain well-controlled gap heights between different optical elements, such as a first optical substrate (e.g., first optical element layer 644) and a second optical substrate (e.g., second optical element layer 648). Instead of relying solely on bulky support structures such as framing members (e.g. framing member 620 and 622) located at the peripheral regions of the AR/VR/MR glasses or goggles, an optical stack can utilize micro spacers positioned within the field of view of the user, along the optical path. The micro spacers maintain separation of the layer of optical elements to effectively reduce the gap height. For example, without the use of micro spacers according to embodiments of the present disclosure, the gap heights 624 and 626 may be, for example, between 1 mm and 2 mm By contrast, when micro spacers are employed within the field of view to separate the optical waveguide 608 and the active dimming layer 606, or to separate the optical waveguide 608 and the eye tracking layer 612, the gap height 624 or 626 may be reduce to, for example, to a gap height is between 2 μm and 200 μm or between 25 μm and 100 μm, according to various embodiments. For example, the gap height may be a 50 μm, 75 μm, 100 μm. In certain embodiments, this represents at least an order of magnitude of reduction in the size of the gap height.

The micro spacers establish a gap sufficient to support proper operation of the optical elements. For example, propagation of the projected light corresponding to a virtual image through the optical waveguide 608 is based on total internal reflection (TIR), which depends on the differential between the respective indices of refraction of two optical materials in either side of a material boundary (i.e., based on Snell's law). According to various embodiments of the disclosure, the first optical substrate has a first index of refraction greater than 1.4, the second optical substrate has a second index of refraction greater than 1.4, and the gap maintained by the micro spacers between the first optical substrate and the second optical substrate comprises a vacuum or partial vacuum, or is at least partially occupied by a material having a third index of refraction less than 1.1. In an embodiment shown in FIG. 6, for example, the optical waveguide 608 (e.g., first optical substrate) may comprise a polycarbonate material with a refractive index of around 1.59. The eye tracking layer may also comprise a polycarbonate material with a refractive index of around 1.59. The gap 626 maintained between the first and the second optical substrates may be occupied by air, which has a refractive index of around 1.0003. Thus, the micro spacers establish a gap sufficient to maintain the differential in indices of refraction for the proper operation of the optical elements (e.g., TIR of the projected light within the optical waveguide 608).

In FIG. 6, one of the micro spacers 642 is shown in a magnified three-dimensional view, as micro pillar 648. Here, the micro spacer is presented as having a generally cylindrical shape with a diameter and height. However, other shapes of micro spacers may be used, such as different types of micro pillars, cones, dots, stripes, blocks, etc. Referring to the top view 660, the plurality of micro spacers 642 may be distributed in a particular pattern within the field of view of the user of the AR goggles. The micro spacers may be arranged in a defined pattern having a non-uniform spacer density, as discussed in more detail in later sections.

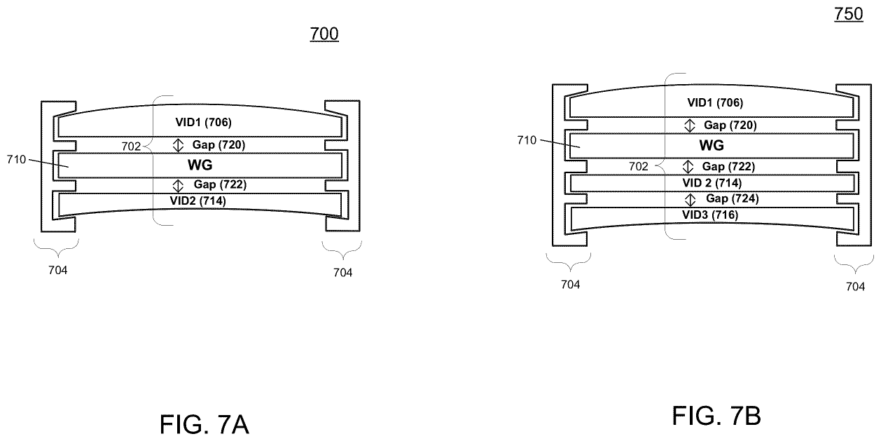

FIG. 7A and FIG. 7B are cross-sectional views of examples of the use of micro spacers to maintain gaps between different optical substrates (e.g., different layers of optical elements). In FIG. 7A, a portion 700 of a pair of AR glasses is shown, comprising an optical stack 702 and a plurality of framing structures 704. The optical stack 702 is arranged in a similar fashion as the optical stack 602 shown in FIG. 6 previously. The optical stack 702 comprises a first lens 706, an optical waveguide 710, and a second lens 714. The first lens 706, the second lens 714, or both, may comprise multiple layers that can provide various functionality. Such functionality may include, for example, vision correction, e.g., prescription (Rx) lens, eye tracking, dimming (including active dimming), various accommodations, etc. The first lens 706, the second lens 714, or both, may serve as a virtual image distance (VID) lens. The optical path traverses all or parts of the optical stack 702. The plurality of framing structures 704 may be optionally employed to support the various layers of optical elements in the optical stack 702 and contribute to maintaining the air gaps between layers. These air gaps include an air gap 720 between the first lens and the optical waveguide 710, as well as an air gap 724 between the optical waveguide 710 and the second lens 714. According to embodiments of the disclosure, micro spacers may be employed to provide support for maintaining separation between various pairs of these optical elements, to significantly reduce the gap height of the air gaps and reduce reliance on use of the framing structure 704. In some embodiments, use of the micro spacers can reduce the size of the framing structure 704 or partially or completely eliminate use of the framing structure 704.

FIG. 7B shows a comparable structure 750 comprising an optical stack 702 and a framing structure 704. However, in FIG. 7B, three air gaps are shown instead of two air gaps. Here, the optical stack 702 comprises a first lens 706, a second lens 714, and a third lens 716. The first lens 706, the second lens 714, the third lens 716, or any combination thereof, may comprise multiple layers that can provide various functionality. Such functionality may include, for example, vision correction, e.g., prescription (Rx) lens, eye tracking, dimming (including active dimming), various accommodations, etc. One or more of the first lens 706, second lens 714, and/or third lens 716 may serve as one or more virtual image distance (VID) lenses. Once again, the optical path traverses all or parts of the optical stack 702. Just as an example, the third lens 716 may be a separate vision correction prescription (RX) layer that is easily removed and replaced when the user's vision correction prescription changes, such that a replacement having a different optical power or other vision correction propert(ies) can be installed. The use of micro pillars, e.g., fixedly attached to the second lens 714, allows for the third lens 716 to be conveniently removed and replaced. When the new (replacement) RX layer is installed, it can be supported by the micro spacers (not shown) such that the same gap height is maintained. The various examples shown in FIGS. 6, 7A, and 7B illustrate that the use of micro spacers according to embodiments of the present disclosure is not necessarily limited to particular types of optical elements. The micro spacers may support different types of optical elements in an optical stack, possibly at multiple locations within the stack, to establish reduced gap heights between adjacent layers of optical elements.

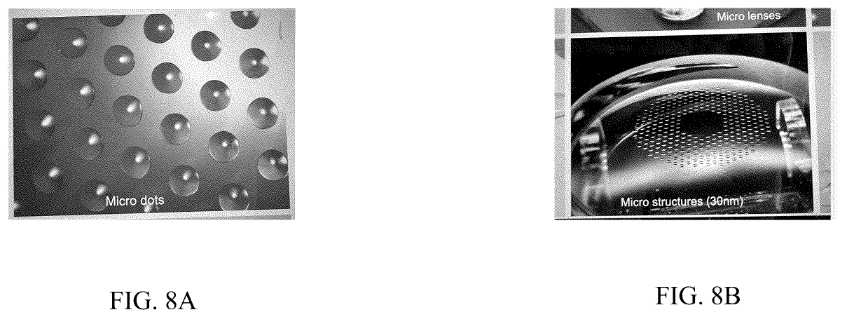

FIGS. 8A and 8B further illustrate that micro spacers according to embodiments of the disclosure may be arranged in a defined pattern, such as a regular hexagonal pattern. In particular, FIG. 8A shows a hexagonal pattern of micro spacers in the form of micro dots. FIG. 8B also shows a hexagonal pattern of micro spacers in the form of micro structures, each micro structure having a linear dimension of around 30 nanometers (nm). FIG. 8A further shows that there may be regions defined as “keep out zones” where micro spacers are not present. For example, in FIG. 8G, a central hexagonal region of the defined pattern is devoid of any micro structures. Such keep out zones may be employed to prevent/reduce interactions between micro spacers and features such as gratings, coatings, and other special features that may be negatively impacted by the presence of micro spacers.

In other embodiments, the pattern of micro spacers positioned between a first optical substrate (e.g., optical element layer 1) and a second optical substrate (e.g., optical element layer 2) may incorporate “contact zones” and “non-contact zones.” Within the contact zone(s), the micro spacers may have a “full height”—i.e., sufficient height to make contact with both the first optical substrate and the second optical substrate. Within the non-contact zone(s), the micro spacers may have a “reduced height”—i.e., such that the micro spacers only make contact with one, but not the other, of the two optical substrates. For instance, during normal operations, the first optical substrate may not be compressed or otherwise deflected toward the second optical substrate (or vice versa). Here, the reduced height of the micro spacers means that they do not make contact with the opposing optical substrate. This can accommodate sensitive components such as gratings or coatings that might be negatively impacted by contact with the micro spacers. But during abnormal operations (e.g., testing or accidental dropping of the AR glasses), when the first optical substrate may be compressed or deflected toward the second optical substrate (or vice versa), the reduced-height micro spacers serve a useful purpose to limit the amount of deflection of the first optical substrate toward the second optical substrate (or vice versa) and prevent collision of the two substrates.

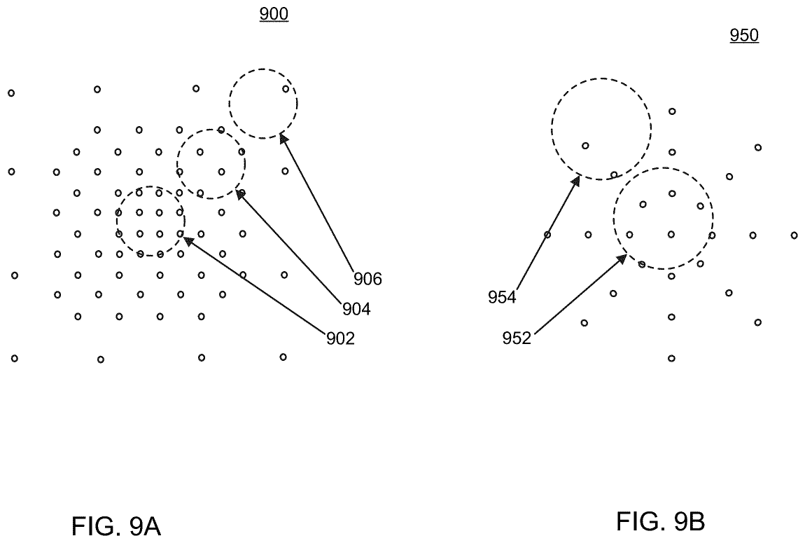

FIGS. 9A and 9B present examples of micro spacers arranged in defined patterns having non-uniform spacer density, according to different embodiments of the disclosure. In FIG. 9A, a defined pattern 900 having non-uniform spacer density is based on a rectangular grid. At a central region 902, the defined pattern 900 has a first spacer density. The spacer density decreases when moving away from the central region 902. For example, at an intermediate region 904, the defined pattern 900 has a second spacer density that is less than the first spacer density. As a further example, at a peripheral region 906, the defined pattern 900 has a third spacer density that is further reduced, i.e., less than the second spacer density. In FIG. 9B, a defined pattern 950 having non-uniform spacer density is based on a star shape. At a central region 952, the defined pattern 950 has a first spacer density. Again, the spacer density decreases when moving away from the central region 952. For example, at a peripheral region 954, the defined pattern 950 has a second spacer density that is less than the first spacer density.

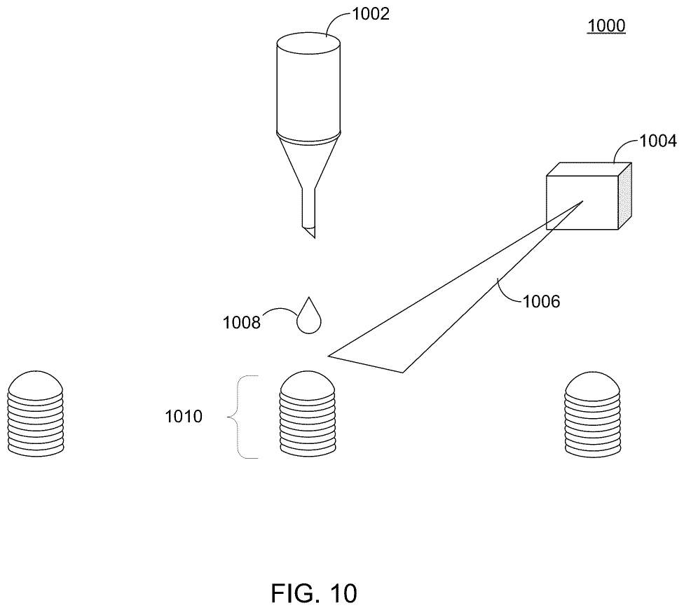

FIG. 10 illustrates a modified 3D printing system 1000 for forming micro spacers according to certain embodiments of the present disclosure. The modified 3D printing system 1000 comprises components including a printing material dispenser head 1002, which may be coupled to a positioning mechanism (not shown) that positions the dispenser head 1002 at programmed locations for dispensing printing material. The modified 3D printing system 1000 may further comprise a light source 1004 for outputting a suitable light beam 1006 for curing the printing material after it is dispensed by the dispenser head 1002 onto the desired target location. An example of the light outputted by the light source 1004 is a beam of ultraviolet (UV) light. An example of the printing material is polymer, such as a UV light-curable resin. According to some embodiments, the printing material is optically clear and has a light transmission rate of greater than 85%. In certain embodiments, the printing material has a light transmission rate between 90% and 92%.

The modified 3D printing system 1000 may operate differently from traditional 3D printing systems. In particular, the modified 3D printing system 1000 may be configured to form a micro spacer structure by dispensing and curing a single drop 1008 of the UV light-curable resin at a time. Here, each micro spacer structure is comprised of multiple layers of cured resin material, forming a stack 1010 of single-drop layers. In traditional 3D printing, the smallest unit of controllable volume (“pixel”) comprises numerous drops of the printing material, and the shape, width and height of each pixel of printing material in a layer is well-characterized. By contrast, a single-drop layer of printing material, when dispensed, has a shape, width, and height that is highly variable according to factors such as the surface tension of the printing material in its liquid form, the surface interaction between the printing material and the substrate, etc. According to embodiments of the present disclosure, these parameters are characterized to accurately estimate the behavior of a single-droplet of the printing material as a layer. Construction of each stack 1010 can thus be based the deposition of single-droplet layers, each drop being dispensed after a previous drop has been dispensed and cured.

Each stack 1010 of single-droplet layers comprises between 1 and 100 layers of single-droplet UV-curable resin material, or between 5 and 40 layers of single-droplet UV-curable resin material, according to various embodiments. The volume of each droplet is less than 10 picolitres, or between 6 and 10 picolitres, according to various embodiments. Each layer of the multiple layers of cured resin in the stack 1010 of single-droplet layers has a diameter less than 30 μm, or a diameter greater than 10 μm and less than 20 μm, according to various embodiments.

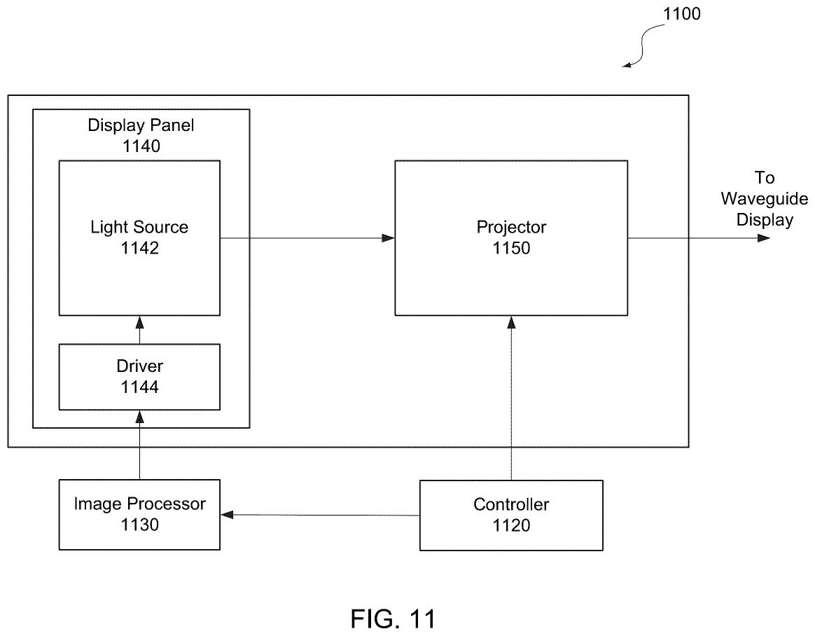

FIG. 11 illustrates an example of an image source assembly 1110 in a near-eye display system according to certain embodiments. Image source assembly 1110 may include, for example, a display panel 1140 that may generate display images to be projected to the user's eyes, and a projector 1150 that may project the display images generated by display panel 1140 to a waveguide display as described above with respect to FIGS. 4-5B. Display panel 1140 may include a light source 1142 and a driver circuit 1144 for light source 1142. Light source 1142 may include, for example, light source 510 or 540. Projector 1150 may include, for example, freeform optical element 560, scanning mirror 570, and/or projection optics 520 described above. Near-eye display system 1100 may also include a controller 1120 that synchronously controls light source 1142 and projector 1150 (e.g., scanning mirror 570). Image source assembly 1110 may generate and output an image light to a waveguide display (not shown in FIG. 11), such as waveguide display 530, 580, 608, or 710, discussed previously. As described above, the waveguide display may receive the image light at one or more input-coupling elements, and guide the received image light to one or more output-coupling elements. The input and output coupling elements may include, for example, a diffraction grating, a holographic grating, a prism, or any combination thereof. The input-coupling element may be chosen such that total internal reflection occurs with the waveguide display. The output-coupling element may couple portions of the total internally reflected image light out of the waveguide display.

As described above, light source 1142 may include a plurality of light emitters arranged in an array or a matrix. Each light emitter may emit monochromatic light, such as red light, blue light, green light, infra-red light, and the like. While RGB colors are often discussed in this disclosure, embodiments described herein are not limited to using red, green, and blue as primary colors. Other colors can also be used as the primary colors of near-eye display system 1100. In some embodiments, a display panel in accordance with an embodiment may use more than three primary colors. Each pixel in light source 1142 may include three subpixels that include a red micro-LED, a green micro-LED, and a blue micro-LED. A semiconductor LED generally includes an active light emitting layer within multiple layers of semiconductor materials. The multiple layers of semiconductor materials may include different compound materials or a same base material with different dopants and/or different doping densities. For example, the multiple layers of semiconductor materials may include an n-type material layer, an active region that may include hetero-structures (e.g., one or more quantum wells), and a p-type material layer. The multiple layers of semiconductor materials may be grown on a surface of a substrate having a certain orientation. In some embodiments, to increase light extraction efficiency, a mesa that includes at least some of the layers of semiconductor materials may be formed.

Controller 1120 may control the image rendering operations of image source assembly 1110, such as the operations of light source 1142 and/or projector 1150. For example, controller 1120 may determine instructions for image source assembly 1110 to render one or more display images. The instructions may include display instructions and scanning instructions. In some embodiments, the display instructions may include an image file (e.g., a bitmap file). The display instructions may be received from, for example, a console, such as console 110 described above with respect to FIG. 1. The scanning instructions may be used by image source assembly 1110 to generate image light. The scanning instructions may specify, for example, a type of a source of image light (e.g., monochromatic or polychromatic), a scanning rate, an orientation of a scanning apparatus, one or more illumination parameters, or any combination thereof. Controller 1120 may include a combination of hardware, software, and/or firmware not shown here so as not to obscure other aspects of the present disclosure.

In some embodiments, controller 1120 may be a graphics processing unit (GPU) of a display device. In other embodiments, controller 1120 may be other kinds of processors. The operations performed by controller 1120 may include taking content for display and dividing the content into discrete sections. Controller 1120 may provide to light source 1142 scanning instructions that include an address corresponding to an individual source element of light source 1142 and/or an electrical bias applied to the individual source element. Controller 1120 may instruct light source 1142 to sequentially present the discrete sections using light emitters corresponding to one or more rows of pixels in an image ultimately displayed to the user. Controller 1120 may also instruct projector 1150 to perform different adjustments of the light. For example, controller 1120 may control projector 1150 to scan the discrete sections to different areas of a coupling element of the waveguide display (e.g., waveguide display 580) as described above with respect to FIG. 5B. As such, at the exit pupil of the waveguide display, each discrete portion is presented in a different respective location. While each discrete section is presented at a different respective time, the presentation and scanning of the discrete sections occur fast enough such that a user's eye may integrate the different sections into a single image or series of images.

Image processor 1130 may be a general-purpose processor and/or one or more application-specific circuits that are dedicated to performing the features described herein. In one embodiment, a general-purpose processor may be coupled to a memory to execute software instructions that cause the processor to perform certain processes described herein. In another embodiment, image processor 1130 may be one or more circuits that are dedicated to performing certain features. While image processor 1130 in FIG. 11 is shown as a stand-alone unit that is separate from controller 1120 and driver circuit 1144, image processor 1130 may be a sub-unit of controller 1120 or driver circuit 1144 in other embodiments. In other words, in those embodiments, controller 1120 or driver circuit 1144 may perform various image processing functions of image processor 1130. Image processor 1130 may also be referred to as an image processing circuit.

In the example shown in FIG. 11, light source 1142 may be driven by driver circuit 1144, based on data or instructions (e.g., display and scanning instructions) sent from controller 1120 or image processor 1130. In one embodiment, driver circuit 1144 may include a circuit panel that connects to and mechanically holds various light emitters of light source 1142. Light source 1142 may emit light in accordance with one or more illumination parameters that are set by the controller 1120 and potentially adjusted by image processor 1130 and driver circuit 1144. An illumination parameter may be used by light source 1142 to generate light. An illumination parameter may include, for example, source wavelength, pulse rate, pulse amplitude, beam type (continuous or pulsed), other parameter(s) that may affect the emitted light, or any combination thereof. In some embodiments, the source light generated by light source 1142 may include multiple beams of red light, green light, and blue light, or any combination thereof.

Projector 1150 may perform a set of optical functions, such as focusing, combining, conditioning, or scanning the image light generated by light source 1142. In some embodiments, projector 1150 may include a combining assembly, a light conditioning assembly, or a scanning mirror assembly. Projector 1150 may include one or more optical components that optically adjust and potentially re-direct the light from light source 1142. One example of the adjustment of light may include conditioning the light, such as expanding, collimating, correcting for one or more optical errors (e.g., field curvature, chromatic aberration, etc.), some other adjustments of the light, or any combination thereof. The optical components of projector 1150 may include, for example, lenses, mirrors, apertures, gratings, or any combination thereof.

Projector 1150 may redirect image light via its one or more reflective and/or refractive portions so that the image light is projected at certain orientations toward the waveguide display. The location where the image light is redirected toward the waveguide display may depend on specific orientations of the one or more reflective and/or refractive portions. In some embodiments, projector 1150 includes a single scanning mirror that scans in at least two dimensions. In other embodiments, projector 1150 may include a plurality of scanning minors that each scan in directions orthogonal to each other. Projector 1150 may perform a raster scan (horizontally or vertically), a bi-resonant scan, or any combination thereof. In some embodiments, projector 1150 may perform a controlled vibration along the horizontal and/or vertical directions with a specific frequency of oscillation to scan along two dimensions and generate a two-dimensional projected image of the media presented to user's eyes. In other embodiments, projector 1150 may include a lens or prism that may serve similar or the same function as one or more scanning mirrors. In some embodiments, image source assembly 1110 may not include a projector, where the light emitted by light source 1142 may be directly incident on the waveguide display.

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

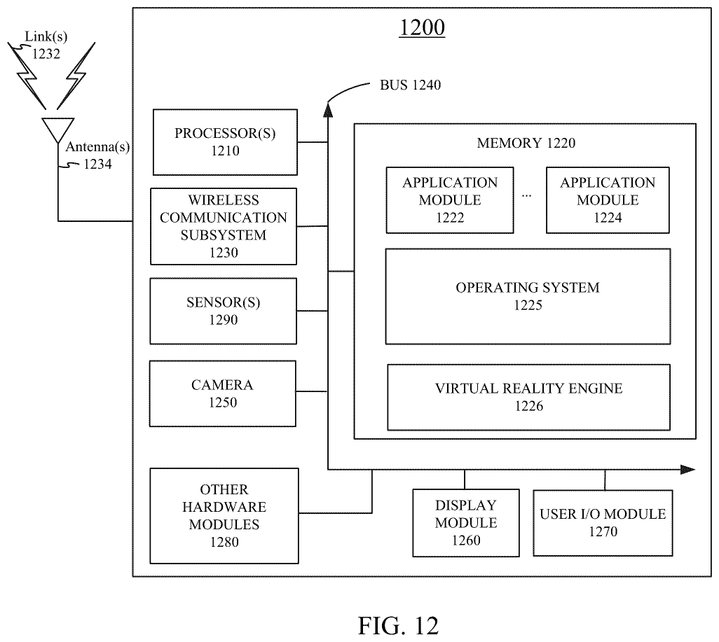

FIG. 12 is a simplified block diagram of an example electronic system 1200 of an example near-eye display (e.g., HMD device) for implementing some of the examples disclosed herein. Electronic system 1200 may be used as the electronic system of an HMD device or other near-eye displays described above. In this example, electronic system 1200 may include one or more processor(s) 1210 and a memory 1220. Processor(s) 1210 may be configured to execute instructions for performing operations at a number of components, and can be, for example, a general-purpose processor or microprocessor suitable for implementation within a portable electronic device. Processor(s) 1210 may be communicatively coupled with a plurality of components within electronic system 1200. To realize this communicative coupling, processor(s) 1210 may communicate with the other illustrated components across a bus 1240. Bus 1240 may be any subsystem adapted to transfer data within electronic system 1200. Bus 1240 may include a plurality of computer buses and additional circuitry to transfer data.

Memory 1220 may be coupled to processor(s) 1210. In some embodiments, memory 1220 may offer both short-term and long-term storage and may be divided into several units. Memory 1220 may be volatile, such as static random access memory (SRAM) and/or dynamic random access memory (DRAM) and/or non-volatile, such as read-only memory (ROM), flash memory, and the like. Furthermore, memory 1220 may include removable storage devices, such as secure digital (SD) cards. Memory 1220 may provide storage of computer-readable instructions, data structures, program modules, and other data for electronic system 1200. In some embodiments, memory 1220 may be distributed into different hardware modules. A set of instructions and/or code might be stored on memory 1220. The instructions might take the form of executable code that may be executable by electronic system 1200, and/or might take the form of source and/or installable code, which, upon compilation and/or installation on electronic system 1200 (e.g., using any of a variety of generally available compilers, installation programs, compression/decompression utilities, etc.), may take the form of executable code.

In some embodiments, memory 1220 may store a plurality of application modules 1222 through 1224, which may include any number of applications. Examples of applications may include gaming applications, conferencing applications, video playback applications, or other suitable applications. The applications may include a depth sensing function or eye tracking function. Application modules 1222-1224 may include particular instructions to be executed by processor(s) 1210. In some embodiments, certain applications or parts of application modules 1222-1224 may be executable by other hardware modules 1280. In certain embodiments, memory 1220 may additionally include secure memory, which may include additional security controls to prevent copying or other unauthorized access to secure information.

In some embodiments, memory 1220 may include an operating system 1225 loaded therein. Operating system 1225 may be operable to initiate the execution of the instructions provided by application modules 1222-1224 and/or manage other hardware modules 1280 as well as interfaces with a wireless communication subsystem 1230 which may include one or more wireless transceivers. Operating system 1225 may be adapted to perform other operations across the components of electronic system 1200 including threading, resource management, data storage control and other similar functionality.

Wireless communication subsystem 1230 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1200 may include one or more antennas 1234 for wireless communication as part of wireless communication subsystem 1230 or as a separate component coupled to any portion of the system. Depending on desired functionality, wireless communication subsystem 1230 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1230 may permit data to be exchanged with a network, other computer systems, and/or any other devices described herein. Wireless communication subsystem 1230 may include a means for transmitting or receiving data, such as identifiers of HMD devices, position data, a geographic map, a heat map, photos, or videos, using antenna(s) 1234 and wireless link(s) 1232. Wireless communication subsystem 1230, processor(s) 1210, and memory 1220 may together comprise at least a part of one or more of a means for performing some functions disclosed herein.

Embodiments of electronic system 1200 may also include one or more sensors 1290. Sensor(s) 1290 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 1290 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or any combination thereof. The position sensors may be located external to the IMU, internal to the IMU, or any combination thereof. At least some sensors may use a structured light pattern for sensing.

Electronic system 1200 may include a display module 1260. Display module 1260 may be a near-eye display, and may graphically present information, such as images, videos, and various instructions, from electronic system 1200 to a user. Such information may be derived from one or more application modules 1222-1224, virtual reality engine 1226, one or more other hardware modules 1280, a combination thereof, or any other suitable means for resolving graphical content for the user (e.g., by operating system 1225). Display module 1260 may use LCD technology, LED technology (including, for example, OLED, ILED, μ-LED, AMOLED, TOLED, etc.), light emitting polymer display (LPD) technology, or some other display technology.

Electronic system 1200 may include a user input/output module 1270. User input/output module 1270 may allow a user to send action requests to electronic system 1200. An action request may be a request to perform a particular action. For example, an action request may be to start or end an application or to perform a particular action within the application. User input/output module 1270 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1200. In some embodiments, user input/output module 1270 may provide haptic feedback to the user in accordance with instructions received from electronic system 1200. For example, the haptic feedback may be provided when an action request is received or has been performed.

Electronic system 1200 may include a camera 1250 that may be used to take photos or videos of a user, for example, for tracking the user's eye position. Camera 1250 may also be used to take photos or videos of the environment, for example, for VR, AR, or MR applications. Camera 1250 may include, for example, a complementary metal-oxide-semiconductor (CMOS) image sensor with a few millions or tens of millions of pixels. In some implementations, camera 1250 may include two or more cameras that may be used to capture 3-D images.

In some embodiments, electronic system 1200 may include a plurality of other hardware modules 1280. Each of other hardware modules 1280 may be a physical module within electronic system 1200. While each of other hardware modules 1280 may be permanently configured as a structure, some of other hardware modules 1280 may be temporarily configured to perform specific functions or temporarily activated. Examples of other hardware modules 1280 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 1280 may be implemented in software.

In some embodiments, memory 1220 of electronic system 1200 may also store a virtual reality engine 1226. Virtual reality engine 1226 may execute applications within electronic system 1200 and receive position information, acceleration information, velocity information, predicted future positions, or any combination thereof of the HMD device from the various sensors. In some embodiments, the information received by virtual reality engine 1226 may be used for producing a signal (e.g., display instructions) to display module 1260. For example, if the received information indicates that the user has looked to the left, virtual reality engine 1226 may generate content for the HMD device that mirrors the user's movement in a virtual environment. Additionally, virtual reality engine 1226 may perform an action within an application in response to an action request received from user input/output module 1270 and provide feedback to the user. The provided feedback may be visual, audible, or haptic feedback. In some implementations, processor(s) 1210 may include one or more GPUs that may execute virtual reality engine 1226.

In various implementations, the above-described hardware and modules may be implemented on a single device or on multiple devices that can communicate with one another using wired or wireless connections. For example, in some implementations, some components or modules, such as GPUs, virtual reality engine 1226, and applications (e.g., tracking application), may be implemented on a console separate from the head-mounted display device. In some implementations, one console may be connected to or support more than one HMD.

In alternative configurations, different and/or additional components may be included in electronic system 1200. Similarly, functionality of one or more of the components can be distributed among the components in a manner different from the manner described above. For example, in some embodiments, electronic system 1200 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A stacked optical assembly comprising:
a first optical substrate having a first index of refraction greater than 1.4;
a second optical substrate having a second index of refraction greater than 1.4 and disposed in a stacked position relative to the first optical substrate; and
a plurality of micro spacers positioned between the first optical substrate and the second optical substrate, wherein:
the plurality of micro spacers maintain a gap having a gap height between the first optical substrate and the second optical substrate,
the plurality of micro spacers are fixedly attached to (a) the first optical substrate, (b) the second optical substrate, or (c) both the first optical substrate and the second optical substrate, and
the gap maintained by the micro spacers between the first optical substrate and the second optical substrate comprises a vacuum or partial vacuum, or is at least partially occupied by a material having a third index of refraction less than 1.1.

2. The stacked optical assembly of claim 1, wherein the plurality of micro spacers are arranged in a defined pattern having a non-uniform spacer density.

3. The stacked optical assembly of claim 2, wherein the non-uniform spacer density decreases when moving from a central region of the defined pattern toward a peripheral region of the defined pattern.

4. The stacked optical assembly of claim 3, where the defined pattern corresponds to a hexagonal grid, a rectangular grid, or a star shape.

5. The stacked optical assembly of claim 1, wherein each of the plurality of micro spacers is formed using a 3D printing process.

6. The stacked optical assembly of claim 5, wherein each of the plurality of micro spacers comprises multiple layers of cured resin material.

7. The stacked optical assembly of claim 6, wherein, for each of the plurality of micro spacers, each layer of the multiple layers of cured resin material comprises a layer cured from a single droplet of the resin material.

8. The stacked optical assembly of claim 7, wherein, for each of the plurality of micro spacers, each layer of the multiple layers of cured resin material has a thickness of less than 5 micrometers (μm).

9. The stacked optical assembly of claim 7, wherein, for each of the plurality of micro spacers, each layer of the multiple layers of cured resin material has a diameter of less than 30 μm.

10. The stacked optical assembly of claim 9, wherein, for each of the plurality of micro spacers, each layer of the multiple layers of cured resin material has a diameter greater than 10 um and less than 20 um.

11. The stacked optical assembly of claim 7, wherein the single droplet of the resin material has a volume of less than 10 picolitres.

12. The stacked optical assembly of claim 11, wherein the single droplet of the resin material has a volume between 6 and 10 picolitres.

13. The stacked optical assembly of claim 7, wherein the multiple layers of cured resin material comprise 5 to 40 layers of single-droplet resin material.

14. The stacked optical assembly of claim 1, wherein the gap height is between 2 μm and 200 μm.

15. The stacked optical assembly of claim 14, wherein the gap height is between 25 μm and 100 μm.

16. The stacked optical assembly of claim 1, wherein each of the plurality of micro spacers has a three-dimensional shape resembling a raised-bump, a column, a cone, a stripe, or a block.

17. The stacked optical assembly of claim 1, wherein at least one of the first optical substrate or the second optical substrate comprises an optical waveguide, an active dimming layer, an eye tracking layer, a glass substrate layer, or a prescription vision correction layer.

18. The stacked optical assembly of claim 1, wherein the plurality of micro spacers comprise a UV curable resin.

19. The stacked optical assembly of claim 1, wherein the plurality of micro spacers have a fourth index or refraction greater than 1.4.

20. The stacked optical structure of claim 19, wherein the fourth index of refraction is 1.52.

21. The stacked optical assembly of claim 1, wherein the plurality of micro spacers comprise a material having a transmission rate greater than 85%.

22. The stacked optical assembly of claim 21, wherein the transmission rate is between 90% and 92%.

23. The stacked optical assembly of claim 1, wherein a first portion of the plurality of micro spacers have a full height, to maintain the gap between the first optical substrate and the second optical substrate, and wherein a second portion of the plurality of micro spacers have a reduced height to prevent collision between the first optical substrate and the second optical substrate.
